(19) United States
(12) Patent Application Publication
(10) Pub. No.: US 2020/0034813 A1
(43) Pub. Date: Jan. 30, 2020

(54) SYSTEMS AND METHODS FOR SCHEDULING BUSINESS-TO-INDIVIDUAL PAYMENTS

(71) Applicant: Wells Fargo Bank, N.A., San Francisco, CA (US)

(72) Inventors: Millicent Calinog, Park City, UT (US); Patricia J. Chouanard-Mcadam, San Francisco, CA (US); Chris Kalaboukis, San Jose, CA (US); Kristine Ing Kushner, Orinda, CA (US); Muhammad Farukh Munir, Pittsburg, CA (US); Raissa Williams, San Francisco, CA (US)

(21) Appl. No.: 16/049,200

(22) Filed: Jul. 30, 2018

(51) Int. Cl. G06Q 20/22

(52) U.S. Cl. CPC G06Q 20/22

(57) ABSTRACT

Systems and methods for facilitating transactions include determining an amount of funds that a payer owes a payee, determining a first payment offer that is for the amount of funds that the payer owes the payee and a first target payment date, providing the first payment offer to the payee, receiving a user input from a payee device, generating a second payment offer of an offered amount of funds and a second target payment date where the offered amount of funds is lower than the amount of funds that the payer owes the payee and the second target payment date is prior to the first target payment date, providing a notification to the payee, receiving a user input from the payee device, and initiating an electronic funds transfer from a source account of the payer to a target account of the payee.

### BACKGROUND

Business organizations frequently need to pay individual payees and typically maintain accounts payable tracking systems for that purpose. For example, individual payees may be customers of the business organization to whom a refund is owed. As another example, individual payees may be subcontractors who have rendered services or sold products to the business organization. Business organizations may make such payments via electronic funds transfers.

Problematically, in such situations, while the individual often wants to receive payment as quickly as possible (for example, to cover a large upcoming expense), the business organization may want to delay making the payment to optimize the cash flow of the business organization. Furthermore, where there is a high number of transactions of various amounts and ages between the same parties, the management of accounts receivable and accounts payable is time-consuming for the payee and the payer, respectively, and requires regular, periodic monitoring. Further still, the service provider (payee) may provide subsidized services to multiple third parties on behalf of the payer. In such situations, accounts receivable and/or accounts payable aggregation and monitoring is time-consuming and may result in a loss of revenue for the payee (such that low-value balances are written off if not collected) and/or suboptimal cash flow for the payer (for example, where a large aggregate payment for the services subsidized by the payer is rendered by the payee to a large number of individuals is due).

### SUMMARY

An example embodiment relates to a computer-implemented method. The method includes determining an amount of funds that a payer owes a payee and determining a first payment offer for the payee. The first payment offer includes the amount of funds that the payer owes the payee and a first target payment date. The method includes providing the first payment offer to the payee via a payee device, receiving a first user input from the payee device indicating a payee preference to receive payment prior to the first target payment date, and generating a second payment offer based on the first user input. The second payment offer includes an offered amount of funds and a second target payment date, such that the offered amount of funds is lower than the amount of funds that the payer owes the payee, and such that the second target payment date is prior to the first target payment date. The method includes providing a notification to the payee device, the notification comprising the second payment offer. The method includes receiving a second user input from the payee device indicating an agreement of the payee with the second payment offer. The method includes initiating, in response to the second user input, an electronic funds transfer from a source account of the payer to a target account of the payee based on the second target payment date.

Another example embodiment refers to a computing system comprising at least one processor. The at least one processor is structured to determine (e.g., calculate, receive, etc.) an amount of funds that a payer owes a payee and a first payment offer for the payee. The first payment offer includes the amount of funds that the payer owes the payee and a first target payment date. The at least one processor is structured to provide the first payment offer to the payee via a payee device, receive a first user input from the payee device indicating a payee preference to receive payment prior to the first target payment date, and generate a second payment offer based on the first user input. The second payment offer includes an offered amount of funds and a second target payment date, such that the offered amount of funds is lower than the amount of funds that the payer owes the payee, and such that the second target payment date is prior to the first target payment date. The at least one processor is structured to provide a notification to the payee device, the notification comprising the second payment offer. The at least one processor is structured to receive a second user input from the payee device indicating an agreement of the payee with the second payment offer. The at least one processor is structured to initiate, in response to the second user input, an electronic funds transfer from a source account of the payer to a target account of the payee based on the second target payment date.

Another example embodiment refers to a non-transitory computer readable medium comprising instructions that, when executed, cause at least one processor of a computing system to perform a computer-implemented method. The method includes determining an amount of funds that a payer owes a payee and determining a first payment offer for the payee. The first payment offer includes the amount of funds that the payer owes the payee and a first target payment date. The method includes providing the first payment offer to the payee via a payee device, receiving a first user input from the payee device indicating a payee preference to receive payment prior to the first target payment date, and generating a second payment offer based on the first user input. The second payment offer includes an offered amount of funds and a second target payment date, such that the offered amount of funds is lower than the amount of funds that the payer owes the payee, and such that the second target payment date is prior to the first target payment date. The method includes providing a notification to the payee device, the notification comprising the second payment offer. The method includes receiving a second user input from the payee device indicating an agreement of the payee with the second payment offer. The method includes initiating, in response to the second user input, an electronic funds transfer from a source account of the payer to a target account of the payee based on the second target payment date.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a block diagram of a system for scheduling business-to-individual payments, according to an example embodiment.

FIG. 2 is a flow diagram of a method of managing business-to-individual payments, according to an example embodiment.

FIG. 3 is a flow diagram of a method of mining payee- and payer-related information to set up business-to-individual payments, according to an example embodiment.

FIG. 4A is an interface on a display of a computing device, the interface including graphics for managing counterparties, managing payments, and initiating quick payments, according to an example embodiment.

FIG. 4B is an interface on a display of a computing device, the interface including graphics for managing payments initiated in FIG. 4A, including displaying a preference list, consensus-scheduled transaction information, and notifications for scheduling business-to-individual payments, according to an example embodiment.

FIG. 4C in an interface on a display of a computing device, the interface including graphics for accepting the terms of quick payments initiated in FIG. 4A, according to an example embodiment.

### DETAILED DESCRIPTION

Referring generally to the figures, systems and methods for scheduling business-to-individual payments according to one or more example embodiments are shown.

A business may need to make a payment to an individual. For example, the individual may have performed a service for the business, and the payment may be compensation for the service. As another example, the business may owe the individual a refund. While the individual often wants to be paid as quickly as possible, the business often wants to delay making the payment to the individual. As will be appreciated, a method performed by an at least one processor of a business-to-individual payment system described herein includes determining an amount of funds that a payer owes a payee and determining a first payment offer for the payee. The first payment offer includes the amount of funds that the payer owes the payee and a first target payment date. The method includes providing the first payment offer to the payee via a payee device, receiving a first user input from the payee device indicating a payee preference to receive payment prior to the first target payment date, and generating a second payment offer based on the first user input. The second payment offer includes an offered amount of funds and a second target payment date, such that the offered amount of funds is lower than the amount of funds that the payer owes the payee, and such that the second target payment date is prior to the first target payment date. The method includes providing a notification to the payee device, the notification comprising the second payment offer. The method includes receiving a second user input from the payee device indicating an agreement of the payee with the second payment offer. The method includes initiating, in response to the second user input, an electronic funds transfer from a source account of the payer to a target account of the payee based on the second target payment date.

The embodiments of the business-to-individual payment system described herein improve computer-related technology by performing certain steps that cannot be done by conventional computing systems or human actors. For example, the business-to-individual payment system is configured to perform pattern mining, by one or more processors of a provider computing system, of data relevant to determining first preferred payment terms for a payee and second preferred payment terms for a payer. The preferred payment terms are used to programmatically generate proposed consensus payment terms. Accurate and realistic predictions of consensus payment terms are facilitated by securely data mining various payee and payer data sources using tokenized credentials. For example, in some embodiments, the pattern mining comprises evaluating cash flow(s) and/or projected cash flow(s) of the payer, payee or both by accessing the party's linked account using the tokenized credentials and analyzing funds inflows, funds outflows, scheduled payments, recurring expenses and/or inflows, etc. Further, accurate and realistic predictions of consensus payment terms are facilitated by using a payment terms pattern repository with at least one attribute descriptive of a property of a previous transaction between the parties.

In some embodiments, to achieve benefits over conventional databases where table and field definitions are static, the attribute of the data repository may be data type agnostic and configured to store different information for different users, transaction types, etc. Furthermore, to achieve benefits over conventional databases, solve the technical problem of improving dimensional scalability (such that different aspects of transactions may be analyzed for different users on the same data storage infrastructure), and streamline the negotiation process between the parties by reducing computer processing times for analyzing the needs and preferences of the parties, the data stored in multidimensional form may be aggregated and/or stored using improved methods. For example, summary data may be dynamically calculated after being stored when the data is retrieved for analysis and/or transaction processing, and to speed up retrieval of the data by reducing the number of steps required to access and retrieve the data stored in summary form.

In an example embodiment, the business-to-individual payment system includes a particular and unique set of rules that are set up to account for and learn from specific transaction patterns.

In addition, embodiments described herein solve the technical problem of determining the appearance and functionality of an electronic user interface providing real time alerts of consensus payment terms to account holders. In some embodiments, alerts can be displayed and consensus payment terms accepted or changed with a single click.

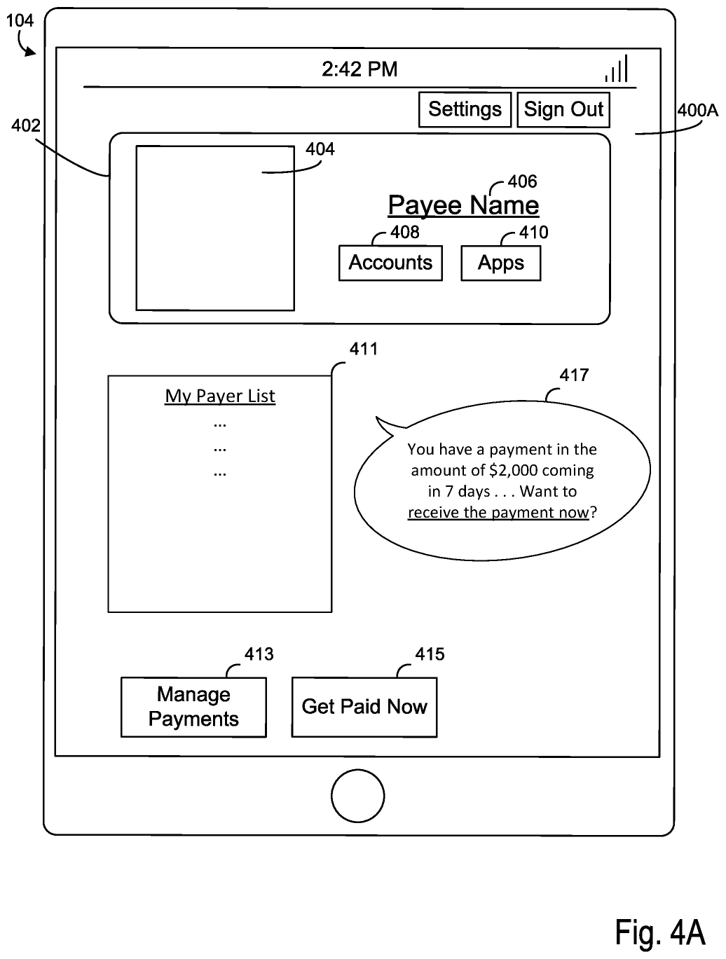

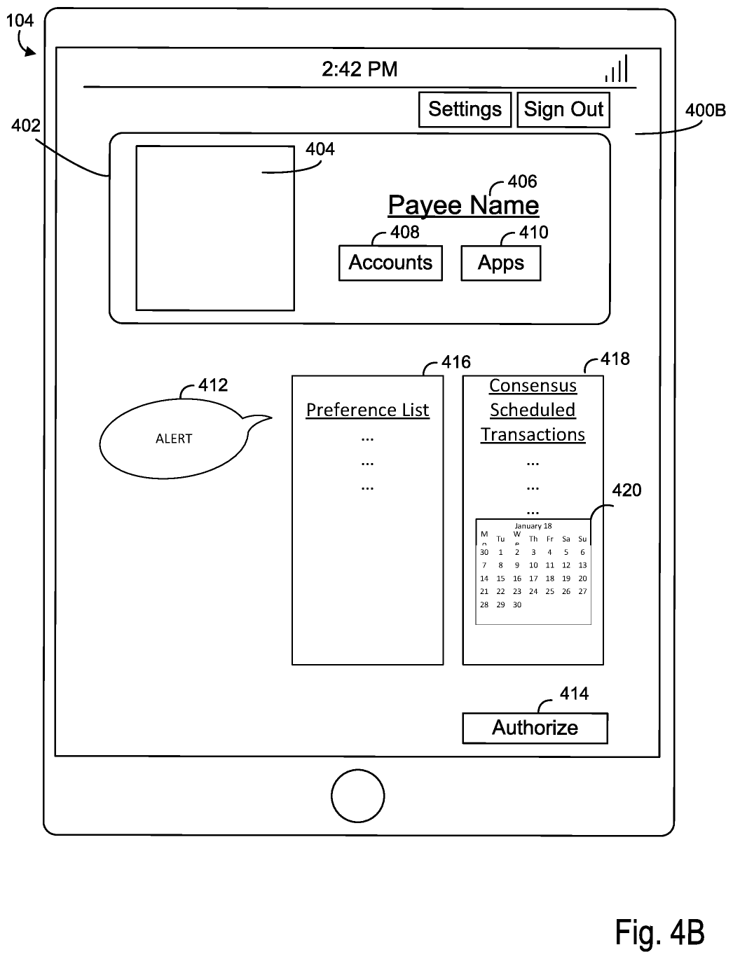

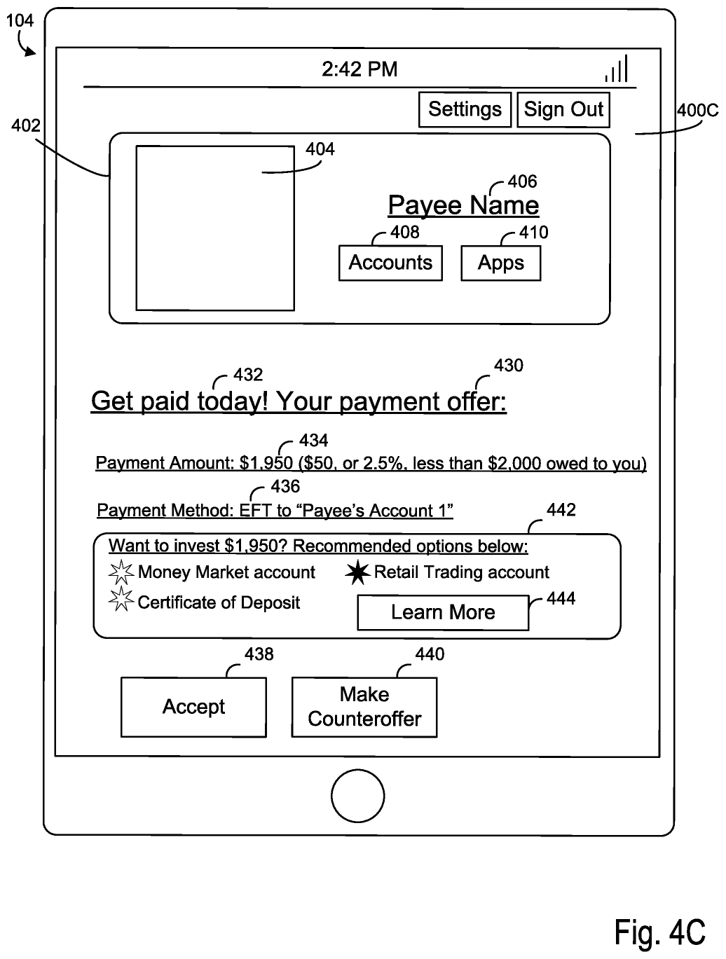

Further still, example embodiments are directed to improved interfaces for managing complex payment arrangements, such as display and notification interfaces for electronic devices with small screens, which may include wearable devices, tablets, mobile phones, and the like. The improved interfaces allow payers and payees to more quickly access desired data and applications through the electronic devices. In some embodiments, such as the embodiment of FIG. 4B, a graphical user interface (GUI) is generated and visually presented to the user through a mobile computing device. The GUI conveniently consolidates information on one form and provides an enriched user experience for information drill-down through on-demand expandable forms (such as pop-up calendar controls). On-demand expandable forms allow the user to quickly analyze and/or provide additional information without having to navigate away from the payment arrangement screen. In some embodiments, electronic user interfaces comprise aural, auditory, tactile, kinesthetic, and/or haptic system(s) and/or component(s) for notifying and interacting with the user to provide alerts without consuming additional screen space so that the user may focus on analyzing the payment arrangement(s) provided through the GUI. For example, the computing device may buzz, vibrate, trigger an LED light indicator, and/or otherwise alert the user to the alert(s) and/or notification(s).

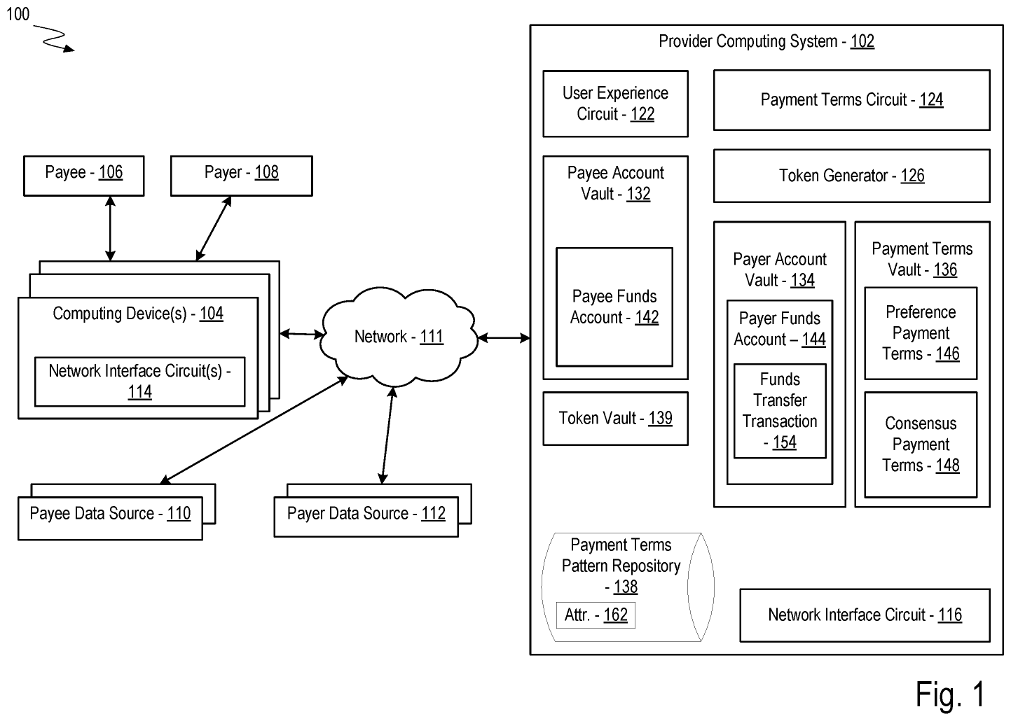

Referring now to FIG. 1, an embodiment of a business-to-individual payment system 100 is depicted. In brief overview, the business-to-individual payment system 100 includes a provider computing system 102, one or more computing device(s) 104 used by one or more payee(s) 106 and/or by one or more payer(s) 108, a payee data source 110, and a payer data source 112.

The payer 108 may be a business that needs to make a payment to an individual, such as the payee 106. For example, payer 108 may owe payee 106 a refund. For instance, payer 108 may be a utility company, a health service provider, a credit card issuer, etc. and may provide overpayment refunds to the payee 106. As another example, payee 106 may have performed a service for the payer 108, and the payment may be compensation for the service. For instance, payee 106 may be an independent contractor (e.g., truck driver, real estate agent, accountant, business consultant, attorney, etc. whose services are engaged by the payer 108), a freelancer (e.g., a writer, graphic designer, software developer, technician, etc.), a temporary worker (e.g., a cleaning person, a landscape designer, etc.), a service provider (e.g., insurance claims processor for a medical office), and/or an on-demand worker (e.g., a driver for Uber™, Lyft™, a childcare provider, a pet care provider, an EAP (employee assistance program) counselor, and the like.) It should be understood that, in some embodiments, the payee 106 is a group of individuals, such as a small business, and/or a legal entity, such as an LLC (limited liability company), LLP (limited liability partnership), and the like.

In some embodiments, payer 108 engages payee 106 on behalf of one or more third parties. For example, payer 108 may be an employer that offers subsidized child care to its employees, and payee 106 may be a childcare provider. The payee 106 may charge the payer 108 for services rendered to multiple individual employees. In such embodiments, the systems and methods of the present disclosure are structured to aggregate multiple payments to determine the amount and payment date for a single amount due. The payment terms for the amount due may be programmatically negotiated using the systems and methods described herein. In some embodiments, the payment terms are programmatically determined/recommended based on the age of individual accounts. For instance, the system and methods may be structured to evaluate the age of each transaction between an employee and the payee 106, group transactions by age (e.g., under 30 days, 30-60 days, 60-90 days, 90-180 days, etc.), determine aggregate amounts due for each age category, and propose varying payment terms based on the age category such that, for example, the age of an account is directly proportionate to the amount of a proposed balance adjustment, write-off, discount, etc.

Payee(s) 106 and payer(s) 108 may hold one or more accounts with one or more entities, such as bank(s), which may serve as data sources for the provider computing system 102. For example, a payee may hold a first account at a first bank, which, in some embodiments, may be the payee data source 110. A payer may hold a second account at a second bank, which, in some embodiments, may be the payer data source 112. In some embodiments, the first bank and the second bank are the same entity. In other embodiments, the first bank and the second bank are different entities.

The computing device(s) 104 of the payee 106 and/or payer 108 are connected to a network 111. Also connected to the network 111 is the provider computing system 102. In some embodiments, the provider computing system 102 is affiliated with, for example, a bank, a credit union, and the like, which may be the same as or different from the payee data source 110 and/or the payer data source 112. In some embodiments, the provider computing system 102 is operated by a trusted intermediary, such as a platform and/or electronic service for connecting payees and payers, processing transactions (e.g., payments for purchased products and/or services, refunds, etc.), and/or facilitating secure transactions. In some embodiments, the provider computing system 102 is operated by a provider and/or operator of the payee data source 110 and/or the payer data source 112. In some embodiments, the provider computing system 102 is operated by a cryptocurrency provider, intermediary, and/or payment processor.

Also connected to the network 111 are the payee data source 110 and/or payer data source 112. The contributors to the payee data source 110 and/or payer data source 112 may include the payee(s) 106 and the payer(s) 108. In an example embodiment, at least one payee 106 is connected to at least one payee data source 110 via the network 111 through the computing device 104. In an example embodiment, at least one payer 108 is connected to at least one payer data source 112 via the network 111 through the computing device 104. In some embodiments, the data from one or more data vault(s) associated with the payee data source 110 and/or the payer data source 112 is accessed and/or received by the provider computing system 102 to identify, create, modify, and manage the business-to-individual payments from the payer 108 to the payee 106, as described further herein.

The computing device(s) 104 communicate over the network 111 with the provider computing system 102, the payee data source 110, and/or the payer data source 112. The computing device(s) 104, according to various embodiments, may comprise smartphones, laptop computers, tablet computers, e-readers, wearable devices (such as a smart watch, a smart bracelet, and the like), and other suitable devices. In reference to components described herein, references to the components in singular or in plural form are not intended as disclaimers of alternative embodiments unless otherwise indicated. In some embodiments, the components are configured to interact, as described in further detail below.

In the business-to-individual payment system 100, electronic communication between the computing device(s) 104, provider computing system 102, the payee data source 110 and/or the payer data source 112 is facilitated by the network 111. The network 111 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some embodiments or combinations, the network 111 includes a local area network or a wide area network. In some embodiments, the network 111 includes the internet. The network 111 is facilitated by short- and/or long-range communication technologies, such as Bluetooth® transceivers, Bluetooth® beacons, RFID transceivers, NFC transceivers, Wi-Fi transceivers, cellular transceivers, wired network connections (e.g., Ethernet), etc.

Each of the computing device(s) 104 and the provider computing system 102 have respective network interface circuits, such as those depicted in FIG. 1 at 114 and 116, respectively. The network interface circuits 114 and 116 may include the components described herein and/or additional similar components that allow and/or facilitate connectivity to the network 111. In some embodiments, data that passes through the respective network interface circuits 114 and 116 is cryptographically protected (e.g., encrypted) such that each of the network interface circuits 114 and 116 is a secure communication module. In some embodiments, data passing through the respective network interface circuits 114 and 116 is tokenized such that sensitive data (for example, account number(s), user location, personally identifying information, and the like) is obscured for transmission within or outside the business-to-individual payment system 100.

Still referring to FIG. 1, in some embodiments, the individuals and/or entities using computing device(s) 104 are in communication with and/or have accounts with a provider entity, such as the entity and/or intermediary associated with the provider computing system 102. Individuals and/or entities include at least one payee 106 and at least one payer 108. In some embodiments, individuals and/or entities include single persons as well as households and families and may also include companies, corporations, or other entities using the system(s) herein to maintain accounts with provider entities. Payee(s) 106 and payer(s) 108 communicate via computing devices 104, and through a respective network interface circuit 114, over the network 111 with the provider computing system 102.

With respect to the provider computing system 102, payee data source 110, and payer data source 112, various configurations are contemplated herein. In one example embodiment, all of the provider computing system 102, payee data source 110, and payer data source 112 are operated by the same entity. In another example embodiment, the provider computing system 102 and the payee data source 110 are operated by a first entity and the payer data source 112 is operated by a second entity different from the first entity. In yet another example embodiment, the provider computing system 102 is operated by a first entity, and the payee data source 110 and the payer data source 112 are operated by a second entity different from the first entity. In yet another example embodiment, each of the provider computing system 102, the payee data source 110, and the payer data source 112 is operated by a separate entity, all three entities being different from each other. As used herein, the term “operated” refers to a computing system being hosted, run, maintained, configured and/or managed to support business operations.

The computing devices 104 are mobile computing systems configured to run applications and communicate with other computer systems over a network 111. For example, the computing devices 104 may be configured to allow payee(s) 106 and/or payer(s) 108 to view account balances, manage accounts, provide loans, and/or transfer funds from a given account by using, for example, a mobile banking circuit (e.g., a circuit formed at least in part by an application associated with and/or connected to the provider computing system 102 and installed on, or otherwise provided to (for example, using the software-as-a-service delivery model), the computing devices) 104). The mobile banking circuit of the computing devices 104 may comprise, be part of, and/or be configured to interact with (for example, through an application programming interface (API)) with one or more circuits of the provider computing system 102, which are described further herein.

The provider computing system 102 facilitates business-to-individual payments. This is accomplished, in an exemplary embodiment, by analyzing information from the payee data source(s) 110 to generate preferred payment terms for the payee 106, calculating a cash flow stream and/or a minimum account balance threshold for the payee 106, analyzing information from the payer data source(s) 112 to generate preferred payment terms for the payer 108, calculating relevant preferred payment terms for the payer 108, analyzing transaction history between the payee 106 and payer 108, generating consensus payment terms, building a notification, providing the notification to the payee 106 and/or the payer 108, obtaining acceptance of consensus payment terms from the payee 106 and/or the payer 108, and initiating an electronic funds transfer from an account associated with the payer 108 to an account associated with the payee 106.

As used herein, “preferred payment terms” mean the aspects of a funds transfer transaction (such as date(s), amount(s), interest rate, etc.) that a party finds acceptable. “Consensus payment terms” mean aspects of a funds transfer transaction that are mutually agreed upon by both/all parties to a transaction (e.g., the payee 106 and the payer 108). In some embodiments, consensus payment terms are proposed at least in part by the payee 106 and/or payer 108. In some embodiments, consensus payment terms are programmatically determined based on, for example, the preferred payment terms of the payee 106 and/or payer 108 (e.g., interest rate, date, frequency of payments, cap on installment payment amounts, cash flow analysis (e.g., analysis of upcoming scheduled expenses, etc.) Consensus payment terms may include at least a consensus payment amount and a consensus payment schedule. According to various embodiments, the consensus payment amount may be the entire amount due or a partial payment amount, such as when the balance is partially written off in exchange for incentives and/or when an installment payment arrangement is negotiated through the consensus payment schedule. The consensus payment schedule may include a range of dates on which a payment may be made.

According to various embodiments, the provider computing system 102 may include at least one electronic circuit and at least one data storage entity. One or more electronic circuit(s) of the provider computing system 102 may be implemented as software code suitable for compilation, object code, executable file(s) and/or code, a set of machine language instructions, and/or in another suitable form for carrying out the computer-implemented method(s) described herein. In some embodiments, the one or more electronic circuit(s) may be implemented in a distributed fashion such that at least some of the code is executed and/or compiled on the computing device(s) 104. One or more data storage entities of the provider computing system 102 may be implemented as an electronic structure(s) suitable for storing information, including, for example, one or more persistent electronic structures, such as one or more database(s), electronic file(s), data mart(s), and the like. The data stored in the one or more data storage entities of the provider computing system 102 may be stored in a multidimensional form such that the structure of the data storage entity has two dimensions (e.g., a look-up table having indexed data) or more (e.g., a relational database, a multi-dimensional database, an online analytical processing (OLAP) cube, etc.). To improve database aggregation time and/or dimensional scalability, the data stored in multidimensional form may be aggregated and/or stored using suitable storage methods such that summary data is calculated prior to being stored (e.g., a block storage method, etc.) or is dynamically calculated after being stored when the data is retrieved for analysis and/or transaction processing (e.g., an aggregate storage method, etc.).

In an example embodiment of FIG. 1, the provider computing system 102 includes electronic circuits and data storage entities. Electronic circuits of the provider computing system 102 include a network interface circuit 116, a user experience circuit 122, a payment terms circuit 124, and a token generator 126. The data storage entities of the provider computing system 102 include a payee account vault 132, a payer account vault 134, a payment terms vault 136, a payment terms pattern repository 138, and a token vault 139. These circuits and/or data storage entities may be combined as needed such that one or more data storage entities and/or circuit(s) are implemented in a hybrid form. An example of a hybrid implementation is a data storage entity having a shell and/or providing an API such that a library of code (for example, executable functions containing Data Manipulation Language (DML) instructions) may be used by entities within or outside the business-to-individual payment system 100.

As described herein, the network interface circuit 116 is structured to enable all or some components of the provider computing system 102 to connect to other systems within or outside the business-to-individual payment system 100.

The user experience circuit 122 is structured to provide the payee(s) 106 and/or the payer(s) 108, through the computing device(s) 104, with subscription notifications and to allow the payee(s) 106 and/or the payer(s) 108 to manage preference list(s) and approve consensus-scheduled transactions.

In some embodiments, the user experience circuit 122 is structured to provide alerts to payee(s) 106 and/or payer(s) 108, through the computing device(s) 104, to allow these individuals to receive and respond to notifications related to business-to-individual payments. For example, the user experience circuit 122 may be configured to generate, manage, update, and/or respond to an electronic user interface for interacting with the individual(s) through the computing device(s) 104. In some embodiments, such as the embodiment of FIGS. 4A and 4B, the electronic user interface is a graphical user interface (GUI) visually presented to the payee(s) 106 and/or payer(s) 108 through the computing device(s) 104. In other embodiments, the electronic user interface may comprise aural, auditory, tactile, kinesthetic, and/or haptic system(s) and/or component(s) for notifying and interacting with the payee(s) 106 and/or payer(s) 108. For example, the computing device(s) 104 may buzz, vibrate, trigger an LED light indicator, and/or otherwise alert the payee(s) 106 and/or the payer(s) 108 to the alert(s) and/or notification(s) received through the user experience circuit 122.

In some embodiments, the user experience circuit 122 allows the payee(s) 106 and/or the payer(s) 108 to approve consensus payment terms for a payment transaction. For example, after the provider computing system 102 identifies the information for and generates individual preferred payment terms and, based at least on this information, generates consensus payment terms for a new payment transaction from the payer 108 to the payee 106, the payee 106 and/or the payer 108 may be presented with a notification allowing each to confirm that they wish to proceed with the payment transaction by accepting consensus payment terms. In some embodiments, the payee 106 and/or the payer 108 may modify some aspects of the consensus payment terms, such as the payment date and/or amount, as part of the authorization process facilitated by the user experience circuit 122.

In some embodiments, the user experience circuit 122 allows the payer 108 to use the business-to-individual payment system 100 to decide which payee(s) 106 the payer 108 would like to use to perform services or provide goods (e.g., such that the payee 106 is a subcontractor of the payer 108 and provides goods and/or services to the payer 108, receiving compensation in return). In some embodiments, the user experience circuit 122 is configured to show, through the electronic user interface rendered to the payer 108 via the computing device 104, the trustworthiness of various individuals (e.g., as rated by other business users of the system, etc.) such that the payer 108 can decide whether a given individual (prospective payee 106) is likely to, for example, still perform if paid up front. In some embodiments, the user experience circuit 122 is configured to provide/display, through the electronic user interface rendered to the payer 108 via the computing device 104, aggregated incentives that various individuals (prospective payee(s) 106) are willing to accept in order to delay a payment, and the payer 108 can select a payee 106 based on the aggregated incentives. For example, the user experience circuit 122 may be configured to show the payer 108 a “swapping path” for various payee(s) 106 such that the payer 108 can see what goods or services each payee 106 can provide, each payee's 106 preferred payment method and/or incentives, and how the two line up. In an example contemplated scenario, the payer 108 may be able to see that individual A would like to be paid with item X and, in exchange, will provide item Y, which individual B would like in exchange for item Z. The payer 108 may be provided, by the user experience circuit 122 and through the electronic user interface rendered to the payer 108 via the computing device 104, with an electronic form for accepting the order in which the individuals A and B should be paid, as well as the method of payment for each individual. In some embodiments, the user experience circuit 122 administers rewards for the payee 106 to encourage late and/or partial payment acceptance. The rewards may be in the form of cash, bonus points, pre-paid gift cards, favorable future contract terms, etc.

The payment terms circuit 124 is structured to analyze payee preference information to generate preferred payment terms for the payee 106, calculate the cash flow stream(s) and/or minimum account balance threshold for the payee 106, analyze information from the payer data source(s) 112 to generate preferred payment terms for the payer 108, calculate relevant preferred payment terms for the payer 108, analyze transaction history between the payee 106 and payer 108, generate consensus payment terms, and initiate an electronic funds transfer from an account associated with the payer 108 to an account associated with the payee 106 based on consensus payment terms.

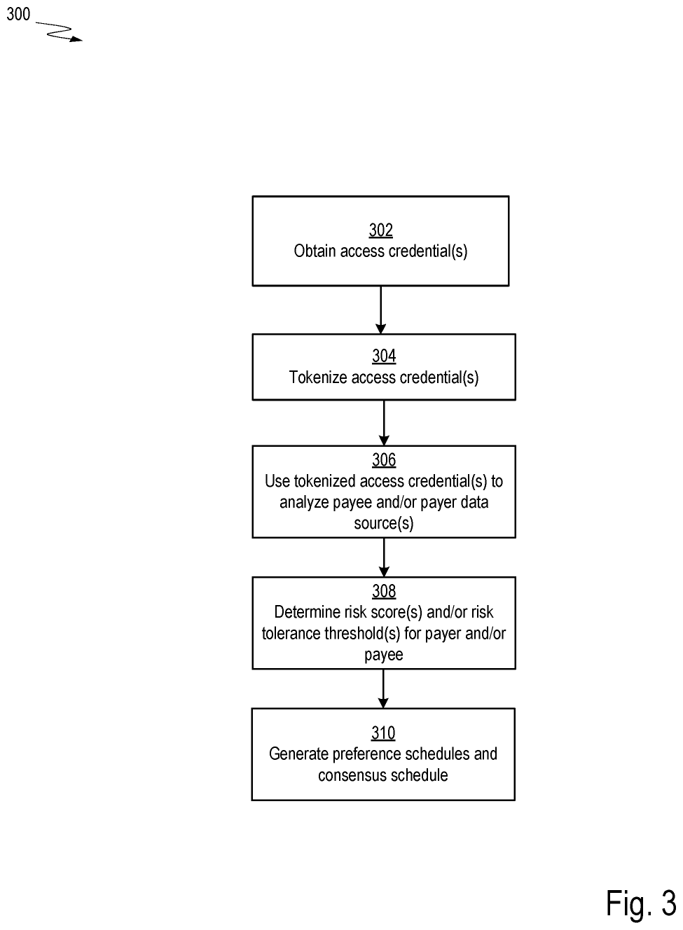

In some embodiments, the payment terms circuit 124 is structured to analyze payee's 106 preference information, generate preferred payment terms for the payee 106, and calculate cash flow, a minimum account balance threshold, and/or other parameters for the payee 106. In an example embodiment, the payee 106 inputs (for example, through an electronic user interface of the computing device 104) the preferences relating to the payee's 106 desired payment timetable. In some embodiments, the preferences include an indication of whether the payee 106 needs at least part of the payment up front in order to perform services or provide a good for the business (payer 108). For example, if the payee 106 is a caterer and the business is paying for catering services, the payee 106 may need at least part of the payment up front in order to buy food for the catering job. In some embodiments, the preferences include an indication of whether the payee 106 needs the payment right away or can afford for the payment to be delayed. For example, as described further in FIG. 3, the individual may provide account information to the provider computing system 102 such that the provider computing system 102 may monitor the level of cash in the individual's account(s). In some embodiments, the preferences include the seasonality of the services provided by the payee 106, such as an indication of when the payee 106 is likely to have work next, etc. In some embodiments, the preferences include an indication of whether the payee 106 is willing to forego some of the total payment amount in exchange for early payment. In some embodiments, the preferences include an indication of whether the payee 106 is willing to defer the payment in exchange for an added amount to the payment, an incentive, a reward, and a share of profits made by the payer 108 because of the deferred payment (e.g., a share in an investment made using the funds while the payment is delayed, etc.). In some embodiments, the preferences include: whether the payee 106 is interested in origination or settlement; the payee's 106 preferred payment method; whether the payee 106 is willing or would like to be paid in something other than cash; and/or whether the payee 106 is willing to allow the payment to be split into smaller installments paid over time.

In some embodiments, rather than or in addition to allowing the payee 106 to enter the payee's preferences through an electronic user interface of the computing device 104, the payment terms circuit 124 is structured to analyze information from one or more payee data source(s) 110 in order to obtain, calculate, project, and/or otherwise generate the payee's 106 preferred payment terms. In some embodiments, the payee data source 110 is a payee funds account, such as the payee funds account 142 residing in the payee account vault 132. The payee account vault 132, according to various embodiments, includes functionality for managing, funding, and initiating transactions using the payee funds account 142 of the payee 106. In some embodiments, the payee data source 110 is an auxiliary computing system operated by a separate provider, credit reporting agency, business credentialing bureau, etc.

In some embodiments, the payment terms circuit 124 is structured to analyze information from the payee data source(s) 110, generate preferred payment terms for the payee 106, and calculate relevant preferred payment terms for the payee 106. The information obtained from the payee data source(s) 110 may include any of the information otherwise manually provided by the payee 106 and/or account balance(s), a risk score, etc. The risk score may include, for example, a credit score received in a data feed or by dynamically accessing a record of the payee 106 maintained by a credit reporting agency such as Experian™, TransUnion™, etc. in the payee data source 110 and/or an internal risk score maintained by the operator of the provider computing system 102. In some embodiments, the payee data source 110 is a financial account of the payee 106, and the payment terms circuit 124 is configured to periodically access the account to monitor the cash level and determine when the payment should be made. The account may be accessed on a predetermined schedule, such as, for example, once a day, once a week, etc.

In some embodiments, the payment terms circuit 124 is structured to obtain access credentials of the payee 106 to the payee data source 110. The access credentials may be collected from the payee 106 using an electronic form rendered through the computing device 104. In some embodiments, the access credentials are tokenized and stored in the token vault 139. For example, in some embodiments, special-purpose token(s) are generated based on the access credentials. In some embodiments, where the token vault 139 is blockchain-based, such as a blockchain-based wallet, the special-purpose tokens may be mineable tokens structured according to the requirements of the host platform. The token vault 139 is configured to facilitate storage of access credentials for accounts on various systems associated with individuals, such as the payee 106 and payer 108. The token vault 139 may include a mapping data structure (such as a table) that correlates (a) a reference to a specific system (such as a URL, an IP address, a MAC address, a network path, etc.) with (b) an individual's personally identifying information (such as an account handle, user name, identification number, account number in combination with a reference to a specific system, email address, social media handle, name, telephone number, email address, residence and/or business address, etc.) and (c) a token used by the individual identified at (b) to access the computing system identified at (a). In some embodiments, the token vault 139 holds a plurality of records for each payee 106 and payer 108. The system(s) referenced in the token vault 139 may include, for example, the payee data source 110, the payer data source 112, the payee account vault 132, the payer account vault 134, the payment terms vault 136, etc. In some embodiments, the token(s) are generated by the token generator 126, which may be configured to reside and/or generate the token(s) within or outside of the provider computing system 102, including, for example, on the computing device 104, within the payee data source 110, and/or within the payer data source 112. In some embodiments, the token vault 139 comprises a data structure for storing a timestamp for each token(s). The token(s) may expire and be replaced with new token(s) at periodic intervals, such as, for example, every week, every month, every quarter, every time a token has been used, after a set number of times a token has been used (for example, between one and ten times), etc.

In some embodiments, the payment terms circuit 124 is structured to analyze the payer's 108 preference information, generate preferred payment terms for the payer 108, and calculate various parameters for the preferred payment terms of the payer 108. In an example embodiment, the payer 108 inputs (for example, through an electronic user interface of the computing device 104) preferences relating to the payer's 108 desired payment timetable. Example preferences or requirements may include the cash on hand that the business has and the timetable of the business's future cash flow. For example, the business may provide account information to the business-to-individual payment system 100 such that the business-to-individual payment system 100 can monitor the level of cash in the business's account(s) (for example, the payer funds account 144). In some embodiments, the preferences include an indication of whether the business is able to make non-cash payments (e.g., payments in goods or services). In some embodiments, the preferences include the timetable of investment opportunities for the business, the level of the business's appetite for risk, which cash flows should go towards paying for which things or vendors, and/or an order in which individuals and vendors should be paid.

In some embodiments, rather than or in addition to allowing the payer 108 to enter the payer's preferences through an electronic user interface of the computing device 104, the payment terms circuit 124 is structured to analyze information from one or more payer data source(s) 112 in order to obtain, calculate, project, and/or otherwise generate the payee's preferred payment terms. In some embodiments, the preferred payment terms are generated based on a cash flow analysis, such that the preferred payment terms do not cause or exacerbate cash flow problems (e.g., an anticipated net negative cash inflow and/or account balance.) In some embodiments, the payer data source 112 is a payer funds account, such as the payer funds account 144 residing in the payer account vault 134. The payer account vault 134, according to various embodiments, includes functionality for managing, funding, and initiating transactions using the payer funds account 144 of the payer 108. In some embodiments, the payer data source 112 is an auxiliary computing system operated by a separate provider, business credentialing bureau, etc. The payer data source 112 may be an accounts receivable system, an accounts payable system, a supply-chain management system, an enterprise resource planning system, etc.

In some embodiments, the payment terms circuit 124 is structured to analyze information from the payer data source(s) 112 to generate preferred payment terms for the payer 108 and to calculate relevant preferred payment terms for the payer 108. The information obtained from the payer data source(s) 112 may include any of the information otherwise manually provided by the payer 108 and/or account balance(s), an investment interest rate, accounts receivable balance(s), accounts payable balance(s), payer's 108 vendor list, payer's 108 vendor priority ranking, payer's 108 balance threshold for the payer funds account 144, etc. In some embodiments, the payer data source 110 is a financial account of the payer 108, and the payment terms circuit 124 is configured to periodically access the account to monitor the cash level and determine when the payment should be made. The account may be accessed on a predetermined schedule, such as, for example, once a day, once a week, etc.

In some embodiments, the payment terms circuit 124 is structured to obtain the access credentials of the payer 108 for the payer data source 112. The access credentials may be collected from the payer 108 using an electronic form rendered through the computing device 104. In some embodiments, the access credentials are tokenized and stored in the token vault 139. The access credential may be tokenized by the token generator 126.

In some embodiments, the payment terms circuit 124 is configured to store the preferred payment terms for the payee 106, payer 108, or both in the payment terms vault 136. The payment terms vault 136 may include an electronic record to identify each payee 106 and/or payer 108. The electronic record references a plurality of preferred payment terms records 146. The payee 106 and/or payer 108 may be identified by an individual's personally identifying information, such as an account handle, user name, identification number, account number in combination with a reference to a specific system, email address, social media handle, name, telephone number, email address, residence and/or business address, etc. In some embodiments, the payee 106 and/or payer 108 are identified by a unique token generated for that individual by the token generator 126, and the token vault 139 may store matching information for correlating the unique token to a specific payee 106 and/or payer 108. In some embodiments, the unique token is set to expire such that all payment terms records 146 associated with the individual identified by the token may also expire. In some embodiments, each of the payment terms records 146 includes an expiration date. In some embodiments, the expiration date is programmatically set by the provider computing system 102. In some embodiments, the expiration date is set by the payee 106 and/or payer 108 through an electronic interface associated with the computing device 104.

In some embodiments, the payment terms circuit 124 is structured to generate consensus payment terms 148, which may be represented by a plurality of electronic records in the payment terms vault 136, each record having a pointer to both the payee 106 and the payer 108. In some embodiments, consensus payment terms 148 comprise a payment offer and/or payment terms offer. In some embodiments, each electronic item representing consensus payment terms 148 is time stamped such that a first time stamp indicates when the payee 106 accepted the consensus payment terms and a second time stamp indicates when the payer 108 accepted the consensus payment terms. In some embodiments, each electronic item representing consensus payment terms 148 includes a data item indicating the status of consensus payment terms 148, such as pending, accepted, disputed, declined, new terms proposed (with a pointer to the corresponding electronic record), etc. In some embodiments, each electronic item representing consensus payment terms 148 contains a first electronic signature of the payee 106 and a second electronic signature of the payer 108 indicating that the status is set and/or verified by the respective party.

As part of generating consensus payment terms 148, the payment terms circuit 124 is structured to use the preferred payment terms 146 to help the business (payer 108) determine when to pay the individual (payee 106). In some embodiments, the payment terms circuit 124 is configured to present the consensus payment terms 148 to the business in a user-friendly manner on the computing device 104 such that the business can determine a timetable for paying the individual by approving pre-calculated consensus payment terms 148 or proposing new consensus payment terms 148. In some embodiments, the payment terms circuit 124 may be configured to provide an electronic user interface to the individual and the business through their respective computing devices 104. The individual may use the user interface to input time/date payment targets. The system may be configured to show the business the individual's preferred timetable for receiving the payment and the individual's preferred payment type. The business can either drag a payment over to the individual to be paid at a specific time or allow the payment to proceed as specified.

In some embodiments, the payment terms circuit 124 is structured to use data analytics, such as cash flow analytics, to recommend a timing of payments based on past payments by the business. According to various embodiments, the payment terms circuit 124 may be structured to programmatically determine an optimized payment timetable (e.g., consensus payment terms 148, etc.) for the business and the individual and/or to optimize a payment schedule based on the preferences, when the business receives payments, when the individual needs payment, the business's interest rates, etc. In some embodiments, the payment terms circuit 124 may be structured to programmatically delay a payment to the individual until the business's payment account balance (e.g., the balance of the payer funds account 144, etc.) reaches a certain threshold and/or until the individual's payment account balance (e.g., the balance of the payee funds account 142, etc.) dips below a certain threshold. In some embodiments, the payment terms circuit 124 may be structured to use data analytics to determine if the business is making a payment out of context and send an alert to the business (e.g., because the payment may be fraudulent, etc.).

In some embodiments, as part of generating consensus payment terms 148, the payment terms circuit 124 is structured to analyze transaction history between the payee 106 and payer 108 so that payments are based on data analytics of past payments made by the business. To facilitate this analysis, in some embodiments, the payment terms circuit 124 is structured to maintain a payment terms pattern repository 138 of the provider computing system 102. The payment terms pattern repository 138 provides a data structure to store and/or manage at least one attribute 162. The attribute 162 may be associated with an individual (such as login information, PIN numbers, social network aliases and the like of the payee 106 and/or the payer 108), a transaction (such as payment amount, date, payee and/or payer identifier(s) (such as a Tax ID), account number of the payee 106 with the payer 108, account balance, account payment terms (such as interest rate, payoff schedule, amortization schedule, and the like), and a payment (such as the interest rate, amount, payment amounts, duration, payment frequency, etc.). In an example embodiment, the payment terms pattern repository 138 is a database optimized for database aggregation time, data retrieval time, and/or dimensional scalability as described herein in relation to various implementations of the data storage entities of the provider computing system 102. In some embodiments, the payment terms pattern repository 138 is optimized for providing statistical and analysis data on the payment activity between payee(s) 106 and/or payer(s) 108. In some embodiments, the payment terms circuit 124 includes a library of code and/or executable code packages that is implemented as wrap-around functionality, such as a shell, for one or more data storage objects comprising the payment terms pattern repository 138.

The payment terms pattern repository 138 may be structured to provide an API such that a library of code associated with the functionality of the circuits of the provider computing system 102 may be accessed by components within or outside the business-to-individual payment system 100. In some embodiments, the executable code package(s) may be provided in a software-as-a-service fashion for execution by or on the computing device 104. According to various embodiments, some or all electronic components of the electronic user interface provided to the payee 106 and/or payer 108 through the computing device 104 may be generated, set, re-set, and/or populated with data by one or more processes running on the computing device 104 and/or managed by a processor of the computing device 104 such that executable code packages can be accessed by, stored, compiled, and/or executed through instructions stored in a memory module of the computing device 104.

In some embodiments, the payment terms circuit 124 is structured to initiate an electronic funds transfer (such as an automatic funds transfer transaction 154 from the payer funds account 144 to the payee funds account 142) based on consensus payment terms. In some embodiments, the payment terms circuit 124 is configured to transfer and/or schedule the funds immediately upon receiving a confirmation of consensus payments terms 148 from the payee 106 and/or the payer 108. In some embodiments, there may be another triggering event before the funds are transferred, such as, for example, reaching a scheduled date of the funds transfer transaction 154. The scheduled date may be determined by defining a range of acceptable dates based on the consensus payment terms 148 and selecting a date from that range of dates. In some embodiments, prior to the funds transfer, the payment terms circuit 124 is configured to check the balance of the payer funds account 144 relative to the amount of the funds transfer transaction 154 to determine whether sufficient funds are available. According to various embodiments, the payment terms circuit 124 may use the preferred funds transfer method(s) of the payee 106 and/or the payer 108 and/or a consensus method. The funds may be transferred from the payer funds account 144 using a suitable payment network and/or protocol, such as automated clearing house (ACH), PayPal™, Google Pay™, BitPay™, Wirex™, etc.

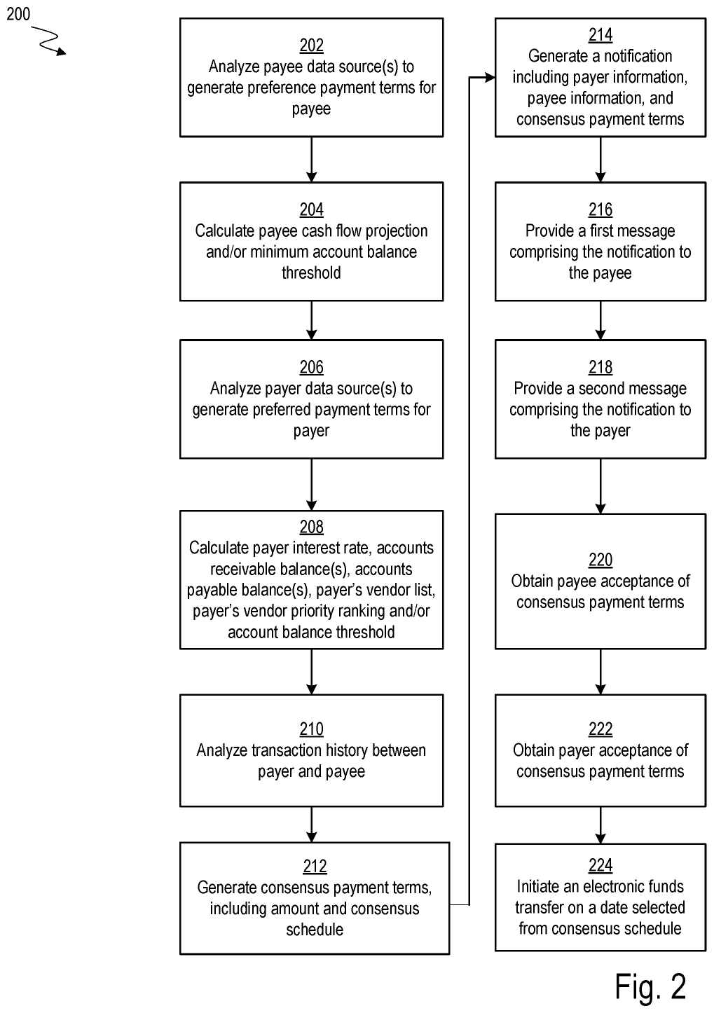

Referring now to FIG. 2, a flow diagram of a method 200 of managing business-to-individual payments is shown, according to an example embodiment. In some embodiments, the method 200 includes programmatic steps for cash flow analysis, such as those described in reference to 202-212. In some embodiments, the method 200 is performed by the provider computing system 102 and/or the computing device 104 such that some or all of the functionality of the electronic circuits of the provider computing system 102 is performed on and/or by the computing device(s) 104 of the payee 106 and/or the payer 108. In some embodiments, the method 200 is performed by the user experience circuit 122, payment terms circuit 124, and/or the token generator 128 of the provider computing system 102. While performing the method 200, the provider computing system 102, for example, communicates data over the network interface circuit 116 of the provider computing system 102, and the computing device(s) 104 communicate data over the network interface circuit 114 of the computing device(s) 104. The method 200 comprises analyzing information from the payee data source(s) 110 to generate preferred payment terms for the payee 106, calculating cash flow and/or minimum account balance threshold for the payee 106, analyzing information from the payer data source(s) 112 to generate preferred payment terms for the payer 108, calculating relevant preferred payment terms for the payer 108, analyzing transaction history between the payee 106 and payer 108, generating consensus payment terms, building a notification, providing the notification to the payee 106 and/or the payer 108, obtaining acceptance of consensus payment terms from the payee 106 and/or the payer 108, and initiating an electronic funds transfer transaction 154 from an account associated with the payer 108 to an account associated with the payee 106.

At 202, the payment terms circuit 124 is structured to pattern mine and/or analyze the payee's 106 data. Based on the analysis of payee's 106 data, the payment terms circuit 124 is structured to generate preferred payment terms 146 for the payee 106. In some embodiments, the payment terms circuit 124 is configured to provide an electronic user interface through the computing device 104 to the payee 106 and to accept user-entered preference information. In some embodiments, the payment terms circuit 124 is configured to pattern mine information from one or more payee data source(s) 110 to collect and/or generate preference information. Here, “pattern mining” is defined as an automated and/or programmatically triggered traversal and/or evaluation by, for example, a bot of electronically stored data selected and/or processed according to a specified set of electronically codified rules in order to identify actionable (able to serve as a basis for identifying preferences of the relevant party as they relate to business-to-individual payments) patterns in the data. In an example embodiment of FIG. 2, determining payee's 106 preferences includes generating and/or updating an electronic record in the payment terms vault 136 to represent first preferred payment terms 146 for the payee 106. First preferred payment terms 146 of the payee 106 include data items for storing at least a first payment schedule for the payee 106. The first payment schedule for the payee 106 represents the preferred timetable of the payee 106 for receiving one or more funds transfer transaction(s) 154 by the payee 106 from the payer 108. According to various embodiments, the first payment schedule may include a single date, a date range, a periodic interval (e.g., monthly, weekly) along with an installment amount, etc. In some embodiments, the first payment schedule includes a plurality of date ranges that represent repayment periods of various lengths and the interest rates set by the payee 106 for the various repayment periods. For example, the payee 106 may allow six installment payments to be made at an interest rate of 5%, twelve installment payments to be made at an interest rate of 6%, twenty-four installment periods to be made at an interest rate of 7%, etc. such that the interest rate the payee 106 charges the payer 108 progressively increases (e.g., by one percentage point) as the length of the repayment period increases (e.g., as the length doubles). In some embodiments, the first preferred payment terms 146 for the payee 106 comprise a preferred method of payment of the payee 106.

At 204, the payment terms circuit 124 is structured to obtain and/or calculate a cash flow projection and/or a minimum balance threshold for the payee funds account 142 of the payee 106. In some embodiments, the payment terms circuit 124 is structured to pattern mine information from one or more payee data source(s) 110 to collect and/or generate preference information. For example, the payee data source(s) 110 may be an asset management system, a financial planning system, etc. The payment terms circuit 124 may be configured to query the payee data source(s) 110 to obtain raw data, such as transactional data on funds inflows and outflows, from the payee data source(s) 110 and, using the raw data, calculate and project the cash flow of the payee 106. In some embodiments, the projected cash flow is the cash flow in the payee funds account 142. In some embodiments, the payee data source 110 is the payment terms pattern repository 138. In some embodiments, the payment terms circuit 124 is structured to obtain additional data from the payment terms pattern repository 138 to supplement the data set obtained from the payee data source(s) 110 in calculating and/or projecting the cash flow and/or the minimum balance. For example, the payee data source 110 may include information about planned expenditures of the payee 106, and the payment terms pattern repository 138 may include information about projected spending patterns of the payee 106, taking the seasonality of the business of the payee 106 into account. Combined, this information may be used by the payment terms circuit 124 to calculate the cash flow and the account balance threshold projections for the payee 106 such that the threshold takes into account contemplated cash outflows from the payee funds account 142 over a given period of time. In some embodiments, the period of time corresponds to the first payment schedule from the first preferred payment terms 146. In some embodiments, the interest rate(s) and repayment terms on the first payment schedule are set based on the projected cash flow and/or minimum balance threshold.

At 206, the payment terms circuit 124 is structured to pattern mine and/or analyze payer's 108 data. Based on the analysis of payer's 108 data, the payment terms circuit 124 is structured to generate preferred payment terms 146 for the payer 108. In some embodiments, the payment terms circuit 124 is configured to provide an electronic user interface through the computing device 104 to the payer 108 and to accept user-entered preference information. In some embodiments, the payment terms circuit 124 is configured to pattern mine information from one or more payer data source(s) 112 to collect and/or generate preference information. In an example embodiment of FIG. 2, determining payer's 108 preferences includes generating and/or updating an electronic record in the payment terms vault 136 to represent second preferred payment terms 146 for the payer 108. Second preferred payment terms 146 of the payer 108 include data items for storing at least a second payment schedule for the payer 108. The second payment schedule for the payer 108 represents the preferred timetable of the payer 108 for making one or more funds transfer transaction(s) 154. According to various embodiments, the second payment schedule may include a single date, a date range, a periodic interval (e.g., monthly, weekly) along with an installment amount, etc. In some embodiments, the second payment schedule includes a plurality of date ranges that represent repayment periods of various lengths and the interest rates proposed by the payer 108 for the various repayment periods. In some embodiments, the second preferred payment terms 146 for the payer 108 comprise a preferred method of payment of the payer 108.

At 208, the payment terms circuit 124 is structured to obtain and/or calculate various aspects of preferred payment terms for the payer 108. The payment terms circuit 124 may be configured to query the payer data source(s) 112 to obtain raw data, such as transactional data on funds inflows and outflows, from the payer data source(s) 112 and, using the raw data, calculate and project variables for payee 106. The information obtained from the payer data source(s) 112 may include account balance(s), an investment interest rate, accounts receivable balance(s), accounts payable balance(s), payer's 108 vendor list, payer's 108 vendor priority ranking, payer's 108 balance threshold for the payer funds account 144, etc. In some embodiments, the payment terms circuit 124 is structured to pattern mine information from one or more payer data source(s) 112 to collect and/or generate the second preferred payment terms 146 for the payer 108. In one example, a projected balance of a payer funds account 144 is used as part of the second preferred payment terms 146 such that the second payment schedule includes a payment date(s) most advantageous for optimizing the cash flow. In another example, the payer data source(s) 112 is an external system that is mined for information on current interest rates, which are used to determine an interest rate the payer 108 may be willing to pay to the payee 106 to defer the funds transfer transaction 154. In some embodiments, the payment terms circuit 124 is structured to identify investment opportunities for the payee 106 and/or the payer 108 and factor these investment opportunities into the payment terms. For example, the payment terms circuit 124 may be structured to identify current offers and interest rates/expected return associated with various financial investments, such as money market accounts, interest-bearing savings accounts, certificates of deposit, commodities, various trades, etc. The payment terms circuit 124 may be configured to determine an investment time window for such opportunities, calculate an expected return on investment within the expected time window, compare the expected return on investment to the amount forfeited by the payee 106 if the payee 106 agrees to accept an earlier reduced payment from the payer 108, and calculate the expected return value for the payee 106 if the reduced payment amount is invested in one of the financial investments. In some embodiments, as shown in FIG. 4C, the investment offers are new account offers or the like associated with the operator of the provider computing system 102 or its affiliates. In some embodiments, the payment terms circuit is configured to present an interactive interface for the payee 106 to accept the one or more investment offer(s) as part of accepting a proposed payment offer from the payee 108.

In yet another example, the payer 108 defines a vendor list where multiple payees 106 are ranked in order of priority. The prioritization may be defined by the payer 108 and/or may be programmatically determined based on, for example, the balance owed to each payee 106, the interest rate, etc. In some embodiments, the payer data source(s) 112 is a social networking system accessed to determine the relationship between the payer 108 and the payee 106 such that, for example, the payer's 108 close contacts and/or family members are paid first or last in relation to other payees 106 in the plurality of payees 106 on the vendor list.

At 210, the payment terms circuit 124 is structured to analyze the history of transactions between the payee 106 and the payer 108. In some embodiments, the transaction history may be factored into the calculation and/or projection of the preferred payment term(s) 146. For example, the payment terms circuit 124 may be configured to mine/analyze the payment terms pattern repository 138. The attribute 162 may be set to a value representing a pairing of payee 106 and payer 108. A data set having this value populated may contain historical transactions between the parties. The payment terms circuit 124 may be configured to analyze various factors to set the preferred payment terms 146, such as timeliness of prior payments, the quality of work performed by the payee 106 as assessed by the payer 108, a history of malpractice claims and/or legal disputes between the parties/outcomes thereof, etc. In some embodiments, the payment terms circuit 124 is configured to use this historical information to generate consensus payment terms 148.

At 212, the payment terms circuit 124 is structured to generate consensus payment terms 148. The consensus payment terms 148 are based at least on the first preferred payment terms 146 and second preferred payment terms 146. The consensus payment terms 148 are programmatically generated by determining a window of opportunity—the set(s) of values where the various aspects of the first preferred payment terms 146 and second preferred payment terms 146 overlap—for consensus between the parties. For example, the first payment schedule proposed by and/or generated by the payee 106 may contain a date range of Jan. 1, 2018 through Jun. 30, 2018, and the second payment schedule of the payer 108 may contain a date range of Mar. 1, 2018 through Dec. 31, 2018. The payee 106 may further prefer an interest rate of 2.5% if a payment is made in installments and if the balance is paid off within three months, and the payer 108 may be willing to pay off the balance in six installments at the same rate. In this example, the payment terms circuit 124 may identify overlaps and generate consensus payment terms 148 that include a consensus payment schedule having a date range of Apr. 1, 2018 through Jun. 30, 2018 and inclusive of proposed bimonthly (twice a month) payments for a total of six installment payments made at an interest rate of 2.5%. The payments would start on Apr. 1, 2018, and all six payments would be made by, for example, Jun. 15, 2018.

At 214, the user experience circuit 122 is structured to build a notification, such as the alert 412 of FIG. 4B. In the example embodiment, the notification is an electronic record that includes data fields populated with values including personally identifying information for the payee 106 and the payer 108. The personally identifying information for the parties may include an account handle, user name, account number in combination with a reference to a specific system, email address, social media handle, name, telephone number, email address, residence and/or business address, etc. The notification further includes consensus payment terms 148, such as the consensus payment amount and the consensus payment schedule. In some embodiments, the notification is a “pull” notification. For example, the notification may be provided in response to the scheduling of a payment by payee 106 and/or payer 108. In such embodiments, the notification may take the form of a confirmation SMS/text message, confirmation email, etc. In some embodiments, such as that of FIG. 4A, the notification is a “push” notification. For example, the notification may be structured to inform the payee 106 that a payment is due to be received on a certain future date.

At 216, the user experience circuit 122 is structured to provide a first electronic message comprising the notification to the payee 106. According to various embodiments, the first electronic message may be provided as an email, text, a pop-up window on the computing device 104 of the payee 106, etc. The first electronic message may contain a link to an executable file accessible by the computing device 104 to instruct the business-to-individual payment system 100 to generate and render an electronic form having an interface for accepting approved and/or edited consensus payment terms 148. For example, a “push” notification that informs payee 106 that a payment is due to be received soon may be structured to provide navigation control (e.g., a link, a button, etc.) for the payee 106 to access a user interface configured to display proposed payment terms if the payee 106 does not want to wait and wishes to receive a partial amount sooner (e.g., in near real-time and/or on the date the notification is accessed on the user device). In some embodiments, the “push” notification is based on a cash flow analysis for the payee 106, including an analysis of anticipated expenses. In some embodiments, the user experience circuit 122 is structured to periodically perform a cash flow analysis for the payee 106 (e.g., weekly, daily, etc.) and identify opportunities for issuing “push” notifications when it is determined that the account of the payee 106 is likely to be overdrawn. In some embodiments, the user experience circuit 122 is structured to analyze the web browsing activity (e.g., search activity, shopping cart activity on online retailer websites, etc.) of the payee 106 to identify a likely upcoming discretionary purchase (e.g., a vacation, a large retail purchase), and in response issue a “push” notification recommending that the payee 106 may receive funds from the payer 108 sooner than scheduled.

At 218, the user experience circuit 122 is structured to provide a second electronic message comprising the notification to the payer 108. According to various embodiments, the second electronic message may be structured similar to or different from the first electronic message. For example, the user experience circuit 122 can be structured to provide the second electronic message in an automated fashion without requiring human involvement (e.g., based on an algorithm decision to accept terms). In some embodiments, the user experience circuit 122 is configured to access and/or determine the information about the device type for the computing device 104 in the token vault 139. In some embodiments, the device type may be determined using a reference to a specific computing device 104 of the payee 106 and/or the payer 108 (such as a URL, an IP address, a MAC address, a network path, etc.) stored in the token vault 139. The reference may be used to ping or otherwise query the computing device 104 and accept a return message indicating the type of the computing device 104. In some embodiments, the type of the computing device 104 is stored in the token vault 139. The type of the computing device 104 may be used to determine a format for the first electronic message and/or the second electronic message.

At 220, the user experience circuit 122 is structured to obtain payee's 106 acceptance of consensus payment terms. According to various embodiments, the first electronic message may contain a link for the payee 106 to click on to indicate acceptance.

At 222, the user experience circuit 122 is structured to obtain payer's 108 acceptance of consensus payment terms. According to various embodiments, the second electronic message may contain a link for the payer 108 to click on to indicate acceptance. In some embodiments, the payer 108 may set thresholds for automatic acceptance of consensus payment terms. The thresholds may comprise a maximum amount, a minimum effective interest rate calculated based on the payment date and amount, how far out the payment is scheduled, etc.

At 224, the payment terms circuit 124 is structured to initiate an electronic funds transfer transaction 154 from the payer funds account 144 to the payee funds account 142. The funds transfer may take place on a date selected from the consensus schedule. In some embodiments, the payment terms circuit 124 is configured to schedule and/or initiate multiple funds transfers. In an example embodiment, the payment amount from the consensus payment terms 148 is a first payment amount, the funds transfer transaction 154 is a first electronic funds transfer, and the date of the funds transfer transaction 154 is a first date of the first electronic funds transfer. Based on the consensus payment terms 148, the payment terms circuit 124 is configured to determine a second payment amount, select a second date for a second electronic funds transfer from the consensus payment schedule, and initiate the second electronic funds transfer from the payer funds account 144 to the payee funds account 142 on the second date.

Referring now to FIG. 3, a flow diagram of a method 300 of mining payee- and payer-related information to set up business-to-individual payments is shown, according to an example embodiment. In some embodiments, the method 300 is performed by the provider computing system 102 and/or the computing device 104 such that some or all of the functionality of the electronic circuits of the provider computing system 102 is performed on and/or by the computing device(s) 104 of the payee 106 and/or the payer 108. In some embodiments, the method 300 is performed by the user experience circuit 122, payment terms circuit 124, and/or the token generator 128 of the provider computing system 102. While performing the method 300, the provider computing system 102, for example, communicates data over the network interface circuit 116 of the provider computing system 102, and the computing device(s) 104 communicate data over the network interface circuit 114 of the computing device(s) 104. The method 300 comprises obtaining access credentials, tokenizing access credentials, using tokenized access credentials to pattern mine a data source, determining risk score(s) and/or risk tolerance threshold(s) based on the mined data, and generating preference schedules and/or consensus schedules.

At 302, the token generator 126 is structured to obtain access credentials of a party, such as the payee 106 and/or the payer 108. According to various embodiments, the access credentials may be obtained from the payee 106 and/or the payer 108 using an electronic form rendered through the computing device 104. The access credentials may include a user ID, a password, a pass phrase, a PIN code, etc. According to various embodiments, the access credentials facilitate access to various components of the business-to-individual payment system 100 and/or auxiliary systems used for pattern mining and data analytics to determine the payment terms.

At 304, the token generator 126 is structured to tokenize the access credentials. In some embodiments, the access credentials are tokenized and stored in the token vault 139. The token vault 139 may include a mapping data structure (such as a table) that correlates (a) a reference to a specific system (such as a URL, an IP address, a MAC address, a network path, etc.) with (b) an individual's personally identifying information (such as an account handle, user name, account number in combination with a reference to a specific system, email address, social media handle, name, telephone number, email address, residence and/or business address, etc.) and (c) with a token used by the individual identified at (b) to access the computing system identified at (a). In some embodiments, the token vault 139 holds a plurality of records for each payee 106 and payer 108. The system(s) referenced in the token vault 139 may include, for example, the payee data source 110, the payer data source 112, the payee account vault 132, the payer account vault 134, the payment terms vault 136, etc. In some embodiments, the token(s) are generated by the token generator 126, which may be configured to reside and/or generate the token(s) within or outside of the provider computing system 102, including, for example, on the computing device 104, within the payee data source 110, and/or within the payer data source 112. In some embodiments, the token vault 139 comprises a data structure for storing a timestamp for each token(s). The token(s) may expire and be replaced with new token(s) at periodic intervals, such as, for example, every week, every month, every quarter, every time a token has been used, after a set number of times a token has been used (for example, between one and ten times), etc.

At 306, the token generator 126 is structured to use the tokenized access credentials to pattern mine the payee data source 110 and/or the payer data source 112. In some embodiments, the payee data source 110 is a payee funds account, such as the payee funds account 142 residing in the payee account vault 132. In some embodiments, the payee data source 110 is an auxiliary computing system operated by a separate provider, credit reporting agency, business credentialing bureau, etc. The payer data source 112 may be an accounts receivable system, accounts payable system, a supply-chain management system, an enterprise resource planning system, etc. The information obtained at step 306 may include transaction history information, credit risk information, etc.

At 308, the payment terms circuit 124 is structured to determine a risk score of the payer 108 and/or a risk tolerance score of the payee 106. The risk score may include, for example, a credit score received in a data feed or by dynamically accessing a record of the payer 108 maintained by a credit reporting agency such as Experian™, TransUnion™, etc. and/or an internal risk score maintained by the operator of the provider computing system 102. In some embodiments, the internal risk score is calculated based on a value of the attribute 162 of the payment terms pattern repository for a relevant subset of prior payment transactions between the payer 108 and various payees 106. For example, the internal risk score may be calculated by evaluating the transaction date against the due date to determine if the payer 108 habitually pays on time. Other examples include evaluating a number of non-sufficient funds (NSF) instances. In some embodiments, the internal risk score is pre-set for the payer 108 by the payee 106 or another entity. In some embodiments, the risk score is compared to the risk tolerance score of the payee 106 to ensure that the level of risk to the payee 106 is acceptable. If the level of risk exceeds the threshold, the payment terms circuit 124 may, for example, be structured to avoid proposing installment payments made over time as part of the consensus payment terms 148.

At 310, the payment terms circuit 124 is structured to generate/calculate the preferred payment terms 146 and/or consensus payment terms 148 as described in reference to FIG. 1 and/or FIG. 2. In some embodiments, these calculations are based at least on the risk information identified at 308.

FIGS. 4A-4C are example embodiments of interfaces 400A-C, respectively, for managing user interaction with the payment terms system 102. In general, example interfaces 400A-C may be graphical user interfaces and may comprise various controls for providing information and accepting user input. Some of these controls (e.g., account holder information 402, avatar 404, username 406, accounts button 408, and/or apps button 410) may be rendered on each of the user interfaces 400A-C to provide a consistent user experience as the user navigates the system. It is to be understood that, while the data provided and the system functions called may differ based on whether the interface(s) 400A-C are presented to the payee 106 or the payer 108, FIGS. 4A-4C generally describe example system functionality accessible to the payee 106 and the payer 108.

Referring now to FIG. 4A, an interface 400A is shown on a display of a computing device 104, the interface 400A including graphics for managing counterparties, managing payments, and initiating quick (expedited) payments, according to an example embodiment. In the example embodiment, the interface 400A is rendered to the payee 106 on a payee 106 device and the counterparties are one or more payers 108. The interface 400A on the display of a computing device 104 includes account holder information 402 for the payee 106, an avatar 404, a username 406, an accounts button 408, and an apps button 410. In some embodiments, the accounts button 408 provides access to one or more accounts (e.g., the payee funds account 142) of the payee 106, where the accounts are held with a provider and/or an intermediary. In some embodiments, the apps button 410 provides access to one or more applications installed on the computing device 104, which may interface (e.g., through an API) with the one or more accounts of the payee 106 and/or the payer 108.

In some embodiments, a graphic is generated to provide payee 106 with a payer list 411. The payer list 411 is populated with records containing information on the payer(s) 108 that have done business with payee 106. In some embodiments, the payer list 411 is a navigable dataset, recordset, etc. The payee 106 may select a payer record from the payer list 411 and click on the manage payments button 413. Responsive to detecting this user activity, the user interface of FIG. 4B may be presented to the payee 106. In some embodiments, the payee 106 may select a payer record from the payer list 411 and click on the get paid now button 415. Responsive to detecting this user activity, the payment terms computing system 102 is configured to display a user interface of example FIG. 4C, which includes the proposed payment terms. If the payee 106 does not want to wait and wishes to receive a partial amount today (e.g., in near real-time on the date the notification is received), payee 106 may accept the terms, which may include a reduced payment amount.

In some embodiments, a “push” notification 417 is provided that informs the payee 106 that a payment is due to be received soon from one of the payers on the payer list 411. The “push” notification 417 may be structured to provide navigation control (e.g., a link, a button, etc.) for the payee 106 to access a user interface (such as that of FIG. 4C) configured to display proposed payment terms.

In some embodiments, the “push” notification 417 is based on a cash flow analysis for the payee 106, including an analysis of anticipated expenses. In some embodiments, the user experience circuit 122 is structured to periodically perform a cash flow analysis for the payee 106 (e.g., weekly, daily, etc.) and identify opportunities for issuing “push” notifications 417 when it is determined that the account of the payee 106 is likely to be overdrawn.

In some embodiments, the user experience circuit 122 is structured to analyze the web browsing activity (e.g., search activity, shopping cart activity, etc.) of the payee 106 to identify a likely upcoming discretionary purchase (e.g., a vacation, a large retail purchase), and in response issue a “push” notification 417 recommending that the payee 106 may receive funds from the payer 108 sooner than scheduled.

According to various embodiments, the “push” notification 417 may be delivered as a pop-up, an updated and newly rendered digital container/form containing other graphics controls for the interface 400, a text message, an email, and the like. The “push” notification 417 may be customized based on the type of the computing device 104 as described in reference to FIG. 2.

Referring now to FIG. 4B, an interface 400 is shown on a display of a computing device 104, the interface 400B including graphics displaying a preference list, consensus-scheduled transaction information, and notifications for scheduling business-to-individual payments, according to an example embodiment. The interface 400B is provided to the payee 106 and/or the payer 108 through the computing device 104. The interface 400B on a display of a computing device 104 includes account holder information 402 for the payee 106 and/or the payer 108, including an avatar 404, a username 406, an accounts button 408, and an apps button 410. In some embodiments, the accounts button 408 provides access to one or more accounts (e.g., the payee funds account 142 and/or the payer funds account 144) of the payee 106 and/or the payer 108, where the accounts are held with a provider and/or an intermediary. In some embodiments, the apps button 410 provides access to one or more applications installed on the computing device 104, which may interface (through, for example, an API) with the one or more accounts of the payee 106 and/or the payer 108.

In some embodiments, a graphic is generated based on a business-to-individual payment scheduling activity, such as the creation of new consensus payment terms 148. For example, the graphic may include an alert 412 indicating that new consensus payment terms 148 were generated involving the payee 106 and/or the payer 108. According to various embodiments of the graphical user interface version of an electronic user interface of the computing device 104, the alert 412 may be delivered as a pop-up, an updated and newly rendered digital container/form containing other graphics controls for the interface 400B, a text message, an email, and the like. The alert may be customized based on the type of the computing device 104 as described in reference to FIG. 2.

In some embodiments, the payee 106 and/or payer 108 use the computing device 104 to click on the alert 412 to obtain more information, including consensus payment terms 148 and the personally identifying information of the counterparty to the funds transfer transaction 154. In some embodiments, the consensus payment terms 148 can be immediately approved by using an authorize button 414. In some embodiments, the user may click on the consensus scheduled transactions graphic 418, which contains link(s) to the scheduled funds transfer transaction(s) 154 and/or the underlying consensus payment terms 148. The user may approve, change, and/or cancel items in the consensus payment terms 148. In the event the consensus payment terms 148 are not approved and are changed or cancelled, the user experience circuit 124 may be configured to generate an updated alert 412 for each party (the payee 106 and the payer 108).

In some embodiments, the preference list graphic 416 allows the payee 106 and/or the payer 108 to enter data regarding the preferred payment terms 146. For example, the payee 106 may click on the preference list graphic 416 to enter a threshold risk score for the payer 108, the payment threshold, a ranking of payers 108, etc. The payer 108 may click on the preference list graphic 416 to enter an acceptable interest rate, rank payees 106, etc. The updated preferences are used by the payment terms circuit 124 to generate and/or update the consensus payment terms 148.

Referring now to FIG. 4C, FIG. 4C includes an interface 400C on a display of the computing device 104, the interface 400C including graphics for accepting the terms of quick payments initiated according to an example embodiment of FIG. 4A. In the example embodiment, the interface 400C is rendered to the payee 106 responsive to detecting user interaction with the get paid now button 415 and/or with the link to “receive the payment now” provided through the “push” notification 417 of FIG. 4A. The interface 400C on a display of a computing device 104 includes account holder information 402 for the payee 106, an avatar 404, a username 406, an accounts button 408, and an apps button 410, which may be structured to operate similar to their counterparts described in relation to FIG. 4A.

In some embodiments, the user experience circuit 122 is structured to generate and provide to the payee 106 a payment offer 430. The payment offer 430 includes the payment date 432, the payment amount 434, and/or the payment method 436. In the example embodiment of FIGS. 4A and 4C, the payment date occurs seven days sooner than the originally scheduled payment date and the payment amount is reduced from $2,000 to $1,950 (or by 2.5% of the original amount.) The differential in payment amounts may be used to determine the effective interest rate that payee 106 will pay the payer 108 to receive the funds sooner. In some embodiments, the payer 108 is provided, via a user interface, with a calculation of an effective interest rate threshold that the payer 108 may charge the payee 106 to remit payment earlier than payment is due while still making the transaction profitable for the payee 106. The effective interest rate threshold may be calculated based on a cash flow projection of the payee 106, a current account balance of the payee 106, interest rates on current investment opportunities for the payee 106, etc. In some embodiments, the payment offer 430 is based on a cash flow situation of the payee. For example, a payment offer requiring the payee to pay a certain percentage of an amount owed (e.g., 10%, 50%, 75% percent) a number of days before the payment would otherwise be due (e.g., 2 days, a week, 10 days early) can be selected if such an early payment would improve the cash flow of the payee. In some embodiments, wherein a difference between an offered amount of funds and the amount of funds that the payer owes the payee is based on a number of days between the first target payment date and the second target payment date. For example, the offered amount of funds can linearly decrease based on the number of days. In another example, the offered amount of funds can exponentially decrease based on the number of days.

In some embodiments, the payment offer 430 further includes pre-determined investment opportunities 442. The predetermined investment opportunities may be selected based on various criteria, such as the credit score of the payee 106, current account balance of the payee 106, prior financial activity of the payee 106, etc. This information may be used to supplement a calculation of an expected return on investment (ROI) associated with various financial accounts, such as money market accounts, certificates of deposit, retail trading accounts, etc. The payee may be presented with a comparative analysis of investment options and with a comparison of the expected ROI realized on the reduced payment amount, invested in full or in part, to the amount forfeited by agreeing to an earlier reduced payment. The comparative analysis may be structured to provide a breakdown by time period, such as by day, by week, by month, etc., showing the difference by time period between the amount forfeited and the ROI. An interactive interface control may be configured to present the pre-determined investment opportunities 442 and accept the payee input (e.g., via button 444). Responsive to detecting a user interaction with the button 444, the interface 400C may be configured to display a web page related to the user's selected investment option.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed:

1. A computer-implemented method performed by one or more processors of a payment terms computing system, the method comprising:
determining an amount of funds that a payer owes a payee;
determining a first payment offer for the payee, the first payment offer comprising the amount of funds that the payer owes the payee and a first target payment date;
providing the first payment offer to the payee via a payee device;
receiving a first user input from the payee device indicating a payee preference to receive payment prior to the first target payment date;
generating a second payment offer based on the first user input, the second payment offer comprising an offered amount of funds and a second target payment date, wherein the offered amount of funds is lower than the amount of funds that the payer owes the payee, and wherein the second target payment date is prior to the first target payment date;
providing a notification to the payee device, the notification comprising the second payment offer;
receiving a second user input from the payee device indicating an agreement of the payee with the second payment offer; and
initiating, in response to the second user input, an electronic funds transfer from a source account of the payer to a target account of the payee based on the second target payment date.

2. The method of claim 1, wherein the payee preference is to receive payment the same day as the receiving of the first user input.

3. The method of claim 1, wherein the difference between the offered amount of funds and the amount of funds that the payer owes the payee is based on a number of days between the first target payment date and the second target payment date.

4. The method of claim 3, wherein the offered amount of funds linearly decreases based on the number of days.

5. The method of claim 3, wherein the offered amount of funds exponentially decreases based on the number of days.

6. The method of claim 1, wherein multiple electronic funds transfers are initiated according to an offered payment schedule.

7. The method of claim 6, wherein the offered payment schedule is structured to maximize an average daily balance of funds in the source account for each day from the second target payment date to a final payment date.

8. The method of claim 1, further comprising mining a payee data repository to determine the first payment offer.

9. The method of claim 8, further comprising:
receiving an access credential for the payee;
tokenizing the access credential to generate a tokenized access credential for the payee; and
using the tokenized access credential to mine the payee data repository.

10. The method of claim 8, further comprising calculating a financial risk score of the payee based on information obtained by mining the payee data repository.

11. The method of claim 1, further comprising mining a payer data repository to determine at least one of the first payment offer and the second payment offer.

12. The method of claim 11, wherein at least one of the first payment offer and the second payment offer is determined based on a history of funds transfers between the payer and the payee.

13. The method of claim 1, wherein the first preferred payment terms of the payee comprise at least one of a payee cash flow projection, a payee account balance threshold, and investment opportunities available to the payee.

14. The method of claim 1, further comprising evaluating at least one of: a projection of an interest rate paid by the payer, an accounts receivable projection of the payer, an accounts payable projection of the payer, a vendor list, a payer account balance threshold, and investment opportunities available to the payer.

15. The method of claim 1, wherein at least one of the first payment offer and the second payment offer is determined based on an evaluation of a seasonality of a financial relationship between the payee and the payer.

16. The method of claim 1, wherein the offered amount is a first payment amount, and the electronic funds transfer is a first electronic funds transfer, the method further comprising:
determining a second payment amount;
selecting a second date of a second electronic funds transfer, the second date of the second electronic funds transfer being different from a first date of the first electronic funds transfer; and
based on the second date, initiating the second electronic funds transfer from the source account of the payer to the target account of the payee.

17. The method of claim 1, wherein the first input from the payee comprises a preferred method of payment; and
wherein at least one of the first payment offer and the second payment offer includes an incentive determined based on the preferred method of payment of the payee;
the method further comprising facilitating a provision of the incentive to the payee in exchange for an adjustment of at least one of the offered amount of funds and the first target payment date.

18. The method of claim 17, wherein the incentive replaces the offered amount of funds in full.

19. The method of claim 1, wherein the payee is a first payee, the method further comprising evaluating preferred payment terms of a second payee to determine coordinated incentives for provision to the first payee and the second payee.

20. A payment terms computing system comprising one or more processors configured to:
determine an amount of funds that a payer owes a payee;
determine a first payment offer for the payee, the first payment offer comprising the amount of funds that the payer owes the payee and a first target payment date;
provide the first payment offer to the payee via a payee device;
receive a first user input from the payee device indicating a payee preference to receive payment prior to the first target payment date;
generate a second payment offer based on the first user input, the second payment offer comprising an offered amount of funds and a second target payment date, wherein the offered amount of funds is lower than the amount of funds that the payer owes the payee, and wherein the second target payment date is prior to the first target payment date;
provide a notification to the payee device, the notification comprising the second payment offer;
receive a second user input from the payee device indicating an agreement of the payee with the second payment offer; and
initiate, in response to the second user input, an electronic funds transfer from a source account of the payer to a target account of the payee based on the second target payment date.

21. The system of claim 20, wherein the first preferred payment terms of the payee comprise at least one of a payee cash flow projection, a payee account balance threshold, and investment opportunities available to the payee.

22. The system of claim 20, further comprising evaluating at least one of: a projection of an interest rate paid by the payer, an accounts receivable projection of the payer, an accounts payable projection of the payer, a vendor list, a payer account balance threshold, and investment opportunities available to the payer.

23. The system of claim 20, wherein the first input from the payee comprises a preferred method of payment, and wherein at least one of the first payment offer and the second payment offer includes an incentive determined based on the preferred method of payment of the payee.

24. A non-transitory computer readable medium containing instructions for causing at least one processor of a computing system to perform operations, the operations comprising:
determining an amount of funds that a payer owes a payee;
determining a first payment offer for the payee, the first payment offer comprising the amount of funds that the payer owes the payee and a first target payment date;
providing the first payment offer to the payee via a payee device;
receiving a first user input from the payee device indicating a payee preference to receive payment prior to the first target payment date;
generating a second payment offer based on the first user input, the second payment offer comprising an offered amount of funds and a second target payment date, wherein the offered amount of funds is lower than the amount of funds that the payer owes the payee, and wherein the second target payment date is prior to the first target payment date;
providing a notification to the payee device, the notification comprising the second payment offer;
receiving a second user input from the payee device indicating an agreement of the payee with the second payment offer; and
initiating, in response to the second user input, an electronic funds transfer from a source account of the payer to a target account of the payee based on the second target payment date.

25. The non-transitory computer readable medium of claim 24, wherein the first preferred payment terms of the payee comprise at least one of a payee cash flow projection, a payee account balance threshold, and investment opportunities available to the payee.

26. The non-transitory computer readable medium of claim 24, wherein the instructions are for further causing the at least one processor to evaluate at least one of: a projection of an interest rate paid by the payer, an accounts receivable projection of the payer, an accounts payable projection of the payer, a vendor list, a payer account balance threshold, and investment opportunities available to the payer.

27. The non-transitory computer readable medium of claim 24, wherein the first input from the payee comprises a preferred method of payment, and wherein at least one of the first payment offer and the second payment offer includes an incentive determined based on the preferred method of payment of the payee.
